(19) United States
(12) Patent Application Publication
(10) Pub. No.: US 2026/0013528 A1
(43) Pub. Date: Jan. 15, 2026

(54) PROTEIN-CONTAINING FOOD AND METHOD FOR PRODUCING THE SAME

(71) Applicant: DAIWA CAN COMPANY, Tokyo (JP)

(72) Inventor: Hiroshi BATORI, Sagamihara-shi (JP)

(73) Assignee: DAIWA CAN COMPANY, Tokyo (JP)

(21) Appl. No.: 19/338,636

(22) Filed: Sep. 24, 2025

Related U.S. Application Data
(63) Continuation of application No. PCT/JP2024/012429, filed on Mar. 27, 2024.

(30) Foreign Application Priority Data
Mar. 31, 2023 (JP) 2023-058643

(51) Int. Cl. A23J 3/04; A23L 29/238; A23L 29/256

(52) U.S. Cl. CPC A23J 3/04; A23L 29/238; A23L 29/256

(57) ABSTRACT

A protein-containing food is provided that contains a high-quality protein at a high concentration, is excellent in taste and flavor, and is also suitable as a food for people with swallowing difficulties, who tend to eat very little. The protein-containing food according to the present embodiment contains a collagen peptide, one or more essential amino acids selected from histidine, isoleucine, leucine, lysine, methionine, phenylalanine, threonine, tryptophan, and valine, and water. In the protein-containing food, the content of the water is 35% by mass or less, and the content of the collagen peptide is 30% by mass or more.

### CROSS REFERENCE TO RELATED APPLICATIONS

This application is a Continuation Application of PCT Application No. PCT/JP2024/012429, filed Mar. 27, 2024 and based upon and claiming the benefit of priority from Japanese Patent Application No. 2023-058643, filed Mar. 31, 2023, the entire contents of all of which are incorporated herein by reference.

### FIELD

The present invention relates to a protein-containing food and a method for producing the same.

### BACKGROUND

In recent years, there has been an increasing demand for foods with physical properties such as softness and low adhesiveness that make swallowing easy, so-called dysphagia diets, as nursing foods for people with chewing or swallowing difficulties such as elderly people. Since people with swallowing difficulties, who tend to eat very little, have difficulty in ingesting nutritional components from normal foods, they need to be able to easily ingest high-quality nutritional components from dysphagia diets. In particular, it is known that protein is essential for maintaining and strengthening muscle strength, and that bedsores are likely to develop in bedridden patients due to protein deficiency. Protein is thus important as a nutritional component, and there is an increasing need for dysphagia diets that contain a high concentration of protein components.

It is preferred that a protein component in a food intended for nutritional supplementation have a nutritionally desirable amino acid composition. For example, the United Nations Food and Agriculture Organization (FAO), the World Health Organization (WHO), and the United Nations University (UNU) jointly set forth the criteria for desirable amino acid compositions in 1985. This compares the amounts of essential amino acids per protein component in a food with the reference amino acid scoring pattern provided by the joint committee of FAO/WHO/UNU, and assesses the proportion of the amino acid in greatest deficit in the form of an amino acid score expressed as a percentage. As a high-quality protein component that enables well-balanced intake of essential amino acids, a protein component preferably has an amino acid score of 80 or more, and more preferably has an amino acid score of 100. An amino acid score of 100 means that there is no amino acid in an insufficient amount relative to the amino acid scoring pattern.

Patent Literature 1 discloses a technique of adding a collagen peptide to a protein component such as whey protein or soybean protein in order to obtain a gel-like food having a high protein content. Collagen peptide, however, contains amino acids in disproportionate amounts and has a low amino acid score; thus, even if the protein content can be increased, it is still difficult to ensure a well-balanced intake of essential amino acids.

Patent Literature 2 discloses a technique of adding a specific egg-white protein to a collagen peptide in order to compensate for the amino acid imbalance in the collagen peptide. However, there are problems with flavor and taste. Under such circumstances, it is desired to develop a dysphagia diet that contains a high concentration of high-quality protein and also has excellent taste and flavor in order to improve the QOL (quality of life) of people with swallowing difficulties.

### CITATION LIST

Patent Literature 1: Jpn. Pat. Appln. KOKAI Publication No. 2020-065547
Patent Literature 2: Jpn. Pat. Appln. KOKAI Publication No. 2015-151378

### SUMMARY

An object of the present invention is to provide a protein-containing food that contains a high-quality protein at a high concentration, is excellent in taste and flavor, and is also suitable as a food for people with swallowing difficulties, and to provide a method for producing the same.

According to an aspect of the present invention, there is provided a protein-containing food that contains a collagen peptide, one or more essential amino acids selected from histidine, isoleucine, leucine, lysine, methionine, phenylalanine, threonine, tryptophan, and valine, and water, wherein a content of the water is 35% by mass or less, and a content of the collagen peptide is 30% by mass or more.

According to another aspect of the present invention, there is provided the protein-containing food according to the above aspect, wherein a content of a protein derived from the collagen peptide is 30% by mass or more.

According to still another aspect of the present invention, there is provided the protein-containing food according to any one of the above aspects, wherein the content of the collagen peptide is in a range of 30% by mass or more and less than 70% by mass.

According to still another aspect of the present invention, there is provided the protein-containing food according to any one of the above aspects, wherein the content of the water is in a range of 10% by mass or more and 33% by mass or less.

According to still another aspect of the present invention, there is provided the protein-containing food according to any one of the above aspects, wherein the protein-containing food has an amino acid score of 100.

There is provided the protein-containing food according to any one of the above aspects, further containing one or more non-essential amino acids, wherein at least tyrosine or cystine is contained as the one or more non-essential amino acids.

According to still another aspect of the present invention, there is provided the protein-containing food according to any one of the above aspects, wherein the protein-containing food contains a gelling agent and is a food for a person with dysphagia having a hardness of 5.0×10⁴ N/m² or less.

According to still another aspect of the present invention, there is provided the protein-containing food according to any one of the above aspects, wherein the protein-containing food has an adhesiveness of 1.5×10³ J/m³ or less.

According to still another aspect of the present invention, there is provided the protein-containing food according to the above aspect, wherein the protein-containing food contains, as the gelling agent, one or more selected from carrageenan, alginic acid or a salt thereof, pectin, agar, konjac, curdlan, xanthan gum, locust bean gum, tamarind seed gum, and gelatin.

According to still another aspect of the present invention, there is provided the protein-containing food according to the above aspect, wherein the protein-containing food is any of gel-like foods including bavarois, mousse, jelly, pudding, almond jelly, and sweet bean jelly.

According to still another aspect of the present invention, there is provided the protein-containing food according to any one of the above aspects, further containing a liquid oil and fat.

According to still another aspect of the present invention, there is provided the protein-containing food according to the above aspect, wherein the protein-containing food contains, as the liquid oil and fat, at least one selected from a vegetable oil and an emulsified oil and fat.

According to still another aspect of the present invention, there is provided a method for producing a protein-containing food, the method including:
mixing water and a collagen peptide to obtain a first solution in which the collagen peptide is dissolved;
adding one or more essential amino acids selected from histidine, isoleucine, leucine, lysine, methionine, phenylalanine, threonine, tryptophan, and valine to the first solution to obtain a second solution in which the one or more essential amino acids are dispersed; and
sterilizing the second solution by heating.

According to the present invention, it is possible to provide a protein-containing food that contains a high-quality protein at a high concentration, is excellent in taste and flavor, and is suitable as a food for people with swallowing difficulties, and to provide a method for producing the same.

### DETAILED DESCRIPTION

Hereinafter, an embodiment of the present invention will be described. The embodiment described below further embodies any one of the above aspects. The matters described below may be incorporated into each of the above aspects alone or in combination.

The embodiment described below is an example of features for embodying the technical idea of the present invention, and the technical idea of the present invention is not limited by the materials, shapes, structures, and the like of the components described below. Various modifications can be made to the technical idea of the present invention within the technical scope defined by the accompanying claims.

The protein-containing food according to the present embodiment is an aqueous food obtained by blending one or more essential amino acids into an aqueous solution containing water and a collagen peptide. Since the solubility limit of collagen peptide in water is 100% or more at normal temperatures (e.g., 20° C.) and normal pressures, the food according to the present embodiment contains a collagen peptide at a high concentration of 30% by mass or more with respect to the total mass of the food. Thus, the food according to the present embodiment contains a protein derived from a collagen peptide at a high concentration, and in one aspect, the content of the protein is 30% by mass or more with respect to the total mass of the food.

Conventionally, milk protein or soybean protein is added to increase the protein content in a food; however, these proteins have a low solubility limit of about 10% in water. Thus, it is difficult to produce an aqueous food that contains a protein in excess of the above-mentioned concentration. In the present embodiment, the use of the collagen peptide having a high solubility limit in water enables a protein to be blended in an aqueous food at a high concentration of 30% by mass or more, as described above. The terms “aqueous food” and “protein-containing food” as used herein both mean the protein-containing food according to the present embodiment, and may also be simply referred to as a “food.”

The collagen peptide used in the present embodiment may be, for example, a collagen peptide obtained by hydrolyzing a collagen derived from an animal such as a pig, a chicken, or a fish with an enzyme or the like to reduce the molecular weight. The weight average molecular weight of the collagen peptide is not particularly limited, and may be, for example, 1000 or more and 10000 or less. The collagen peptide may be a commercially available product.

As described above, the content of the collagen peptide in the protein-containing food is 30% by mass or more, and may preferably be in a range of 308 by mass or more and less than 70% by mass, in a range of 30% by mass or more and 65% by mass or less, or in a range of 35% by mass or more and 60% by mass or less, based on the total mass of the food.

The aqueous food according to the present embodiment contains one or more essential amino acids. The essential amino acids herein mean histidine, isoleucine, leucine, lysine, methionine, phenylalanine, threonine, tryptophan, and valine. As described above, the amino acids constituting collagen peptide are imbalanced. Even if a high protein concentration of 30% by mass or more can be achieved by blending a collagen peptide into an aqueous food, the amino acid score is still low with collagen peptide alone, and protein cannot be used efficiently in the body. On the other hand, it has been found through intensive studies that if a protein having a low solubility limit in water, such as milk protein or soybean protein, is added to an aqueous food that contains a collagen peptide, the solution rapidly loses fluidity, and a desired food for a person with dysphagia cannot be obtained. In contrast, the food according to the present embodiment improves the amino acid balance of the protein contained in the aqueous food that contains a collagen peptide by blending, into the food, an essential amino acid not contained in a sufficient amount. Specifically, an essential amino acid in an insufficient amount in comparison with the above-described amino acid scoring pattern is blended to improve the amino acid score. The protein-containing food according to the present embodiment preferably has an amino acid score of 100.

As described above, the amino acid score is a way of evaluating the nutrition of protein based on the amino acid composition proposed by the joint committee of FAO/WHO/UNU in 1985 and shows the criteria for determining whether or not essential amino acids contained in a food satisfy required amounts. This compares the amounts of essential amino acids per protein component in a food with the reference amino acid scoring pattern provided by the joint committee of FAO/WHO/UNU, and assesses the proportion of the amino acid in greatest deficit in the form of an amino acid score expressed as a percentage. If there is no essential amino acid in an insufficient amount, in other words, if the lowest value of the percentage calculated for each essential amino acid is greater than 100, the amino acid score is determined to be 100. As a high-quality protein component that enables a well-balanced intake of essential amino acids, a protein component preferably has an amino acid score of 80 or more, and more preferably has an amino acid score of 100.

Here, the amino acid score is calculated using the amino acid scoring pattern of people aged 18 years old or older among the age categories of the amino acid scoring pattern (revised in 2007) by FAO/WHO/UNU. For example, collagen peptides from pigs contain a particularly low amount of tryptophan among the essential amino acids, and have the lowest value in comparison with the amino acid scoring pattern. In this case, the ratio of tryptophan (mg/protein) contained in a collagen peptide to tryptophan (mg/protein) in the amino acid scoring pattern expressed as a percentage is the amino acid score of the collagen peptide. The amino acid score of the collagen peptide calculated in Test Example 1 of the Examples described later was 1.7.

Examples of the essential amino acid to be blended into the food according to the present embodiment include essential amino acids such as tryptophan, in which collagen peptide is deficient in light of the comparison between the amino acid scoring pattern and collagen peptide. In Test Example 3 described later, all the essential amino acids except threonine, in which the collagen peptide derived from a pig was not deficient, among the above-mentioned essential amino acids, that is, histidine, isoleucine, leucine, lysine, methionine, phenylalanine, tryptophan, and valine, were added. This does not mean that a case of blending in essential amino acids that are contained in sufficient amounts or amino acids that are not essential amino acids (i.e., non-essential amino acids) is to be excluded. The blending ratio of each essential amino acid that is blended in is determined so as to obtain a desired amino acid score. For example, the blending ratio of each essential amino acid that is blended in in the present embodiment is determined such that the amino acid score of the food according to the present embodiment will be 100.

Essential amino acids have a peculiar odor and taste, with bitterness as the main taste characteristic. In the case of obtaining a protein-containing food that contains essential amino acids in well-balanced proportions and achieves an amino acid score of 100 by blending in the essential amino acid(s) in which collagen peptide is deficient, the odor and taste peculiar to essential amino acids become a problem. If the undesirable odor and taste originating in essential amino acids cannot be suppressed, it is not possible to provide a food that contains a high concentration of high-quality protein that allows well-balanced intake of essential amino acids. Thus, the inventors conducted intensive studies on the means for suppressing the odor and taste of essential amino acids, and found that the odor and taste originating in essential amino acids can be masked by suppressing the water content in protein-containing foods.

The water content of the protein-containing food according to the present embodiment is set to 35% by mass or less with respect to the total mass of the protein-containing food, thereby effectively suppressing the odor and taste originating in essential amino acids. On the other hand, from the viewpoint of the solubility of the collagen peptide in water, the solubility in water of the later-described gelling agent as an optional component, or the like, the water content is preferably 10% by mass or more. Thus, in the food according to the present embodiment, the water content is preferably in a range of 10% by mass or more and 35% by mass or less, more preferably in a range of 108 by mass or more and 33% by mass or less, and still more preferably in a range of 10% by mass or more and 30% by mass or less.

The food according to the present embodiment preferably further contains a liquid oil and fat. By blending in a liquid oil and fat, the masking effect against the odor and taste originating in essential amino acids is improved. The liquid oil and fat may be any edible oil that is liquid at least at room temperature, and specific examples thereof include vegetable oils such as salad oil, sunflower oil, rapeseed oil, soybean oil, sesame oil, cottonseed oil, rice oil, olive oil, linseed oil, corn oil, and palm oil, and emulsified oils and fats. The emulsified oils and fats may be those obtained by adding an emulsifier or the like to oils and fats to emulsify them, and for example, a commercially available product such as “AR white” (manufactured by NOF Corporation) may be used. In one aspect, it is preferable to use a vegetable oil and an emulsified oil and fat in combination as the liquid oil and fat.

In one aspect, the food according to the present embodiment further contains a gelling agent. The food according to the present embodiment contains a collagen peptide at a high content and has a low moisture content. Thus, if a large amount of collagen peptide and a small amount of water are mixed together in the production process, the viscosity of the solution increases, and the resulting food has high adhesiveness and tends to be a food that is difficult for a person with dysphagia to swallow. In this case, blending in a gelling agent makes it easy to adjust the hardness and adhesiveness to a range suitable as a food for a person with dysphagia, and a food with physical properties such as softness and low adhesiveness that make swallowing easy can be obtained. Also, blending in a gelling agent improves the masking effect against the peculiar odor and taste originating in essential amino acids, and further improves the taste and flavor of the food. The food according to the present embodiment may be a gel-like food such as a bavarois-like, mousse-like, jelly-like, pudding-like, or sweet bean jelly-like food.

Any gelling agent that is used in the food field can be used as the gelling agent. The gelling agent includes a gelling agent which is gelled by a divalent metal ion, and a gelling agent which is gelled by heating or cooling after heating. Specific examples of the gelling agent include carrageenan, alginic acid or a salt thereof, pectin, agar, konjak, curdlan, xanthan gum, locust bean gum, tamarind seed gum, gelatin, and dried egg white, and one of them may be used alone, or two or more of them may be used in combination. Examples of the combination of two gelling agents include a combination of carrageenan and locust bean gum, and a combination of xanthan gum and locust bean gum. Also, from the viewpoint of further reducing the adhesiveness, it is preferable to use a gelling agent other than dried egg white among the above specific examples of the gelling agent.

According to an example, the protein-containing food according to the present embodiment is provided as a food for a person with dysphagia.

According to the Universal Design Food (UDF) criteria by the Japan Care Food Conference, foods are classified into four categories in accordance with hardness and the like: “Easy to chew,” “Can be broken down with gums,” “Can be broken down with the tongue,” and “Does not require chewing.” The hardness of the foods in the category “Easy to chew” is required to be 5×10⁵ N/m² or less, the hardness of the foods in the category “Can be broken down with gums” is required to be 5×10⁴ N/m² or less, the hardness of the foods in the category “Can be broken down with the tongue” is required to be 2×10⁴ N/m² or less, and the hardness of the foods in the category “Does not require chewing” is required to be 5×10³ N/m² or less.

The protein-containing food according to the present embodiment preferably has a hardness of, for example, 5×10⁴ N/m² or less.

According to the “approval standards for labeling foods intended for people with swallowing difficulties” of the Consumer Affairs Agency, foods are classified into three categories, that is, evaluation standards I, II, and III, in accordance with the adhesiveness and the like. The adhesiveness of the foods in evaluation standard I is required to be 4×10² J/m³ or less, the adhesiveness of the foods in evaluation standard II is required to be 1×10³ J/m³ or less, and the adhesiveness of the foods in evaluation standard III is required to be 1.5×10³ J/m³ or less.

The protein-containing food according to the present embodiment preferably has an adhesiveness of, for example, 1.5×10³ J/m³ or less.

The hardness and adhesiveness of the food according to the present embodiment are measured by the following method. A device capable of measuring the compressive stress of a substance through linear motion is used as a measuring device. A container having a diameter of 40 mm is filled with a sample at a height of 15 mm, the sample is compressed with a plunger having a diameter of 20 mm, and the compressive stress is measured. The measurement is performed at a temperature of 20±2° C. and a compression rate of 10 mm/sec, until the clearance between the bottom surface of the container and the plunger reaches 5 mm. If the sample has a non-fixed shape, for example, the measurement may be performed with the clearance set to 30% of the thickness of the sample. The measurement is performed five times, and the average of the values from three measurements excluding the maximum value and the minimum value is taken as a measured value.

The food according to the present embodiment may be a gel-like food such as bavarois, mousse, jelly, pudding, almond jelly, or sweet bean jelly. The food according to the present embodiment may contain components usually used in the aforementioned foods, as necessary, in addition to the gelling agent or the liquid oil and fat. The food according to the present embodiment may contain components such as a sweetener, fruit juice, flavor powder, a flavorant, an acidulant, starch, a preservative, a colorant, a dispersant, a carbohydrate, a lipid, and a water-soluble dietary fiber.

The protein-containing food according to the present embodiment can be prepared by, for example, the following method. That is, the protein-containing food according to the present embodiment is prepared by a method including:
(1) mixing water and a collagen peptide under stirring to obtain a first solution in which the collagen peptide is dissolved;
(2) adding various essential amino acids to the first solution under stirring to obtain a second solution in which the essential amino acids are dispersed; and
(3) sterilizing the second solution by heating.

In the case of using a liquid oil and fat, the liquid oil and fat may be added, for example, in step (1). In the case of using a gelling agent, the gelling agent may be added, for example, between step (1) and step (2) or between step (2) and step (3). The order of using the collagen peptide and the various essential amino acids may be reversed.

### EXAMPLES

The results of the tests conducted in connection with the present invention are shown below.

### (Test Example 1) Amino Acid Score of Collagen Peptide

Table 1 shows the amino acid composition of a collagen peptide derived from a pig and the amino acid scoring pattern. Here, the essential amino acid composition of the collagen peptide derived from a pig was determined with reference to the Standard Tables of Food Composition in Japan—2020—(Eighth Revised Edition). The protein content in the collagen peptide was 87.6% by mass. Also, as the amino acid scoring pattern, a set of values (revised in 2007) obtained by converting the amino acid scoring pattern (mg/gN) published by FAO/WHO/UNU in 1985 into the amounts of essential amino acids per protein (mg/g protein) was used.

TABLE 1

| | | Collagen peptide | | |
|---|---|---|---|---|
| | | Amount per | | |
| | | 100 g of | | |
| | | collagen | Amount per 1 g | Amino acid |
| | | peptide | of protein | scoring pattern |
| Amino acid | | (mg/100 g) | (mg/g protein) | (mg/g protein) |
| Isoleucine (ILE) | | 1200 | 14.0 | 30 |
| Leucine (LEU) | | 2900 | 34.0 | 59 |
| Lysine (LYS) | | 3600 | 42.0 | 45 |
| Sulfur- | Methionine (MET) | 830 | 9.6 | — |
| containing | Cystine (CYS) | 17 | 0.2 | — |
| amino acid | Total | 850 | 9.8 | 22 |
| (AAS) | | | | |
| Aromatic | Phenylalanine (PHE) | 2000 | 23.0 | — |
| amino acid | Tyrosine (TYR) | 280 | 3.3 | — |
| (AAA) | Total | 2300 | 26.0 | 38 |

| | | | |
|---|---|---|---|
| Threonine (THR) | 2000 | 23.0 | 23 |
| Tryptophan (TRP) | 7.7 | 0.1 | 6 |
| Valine (VAL) | 2700 | 31.0 | 39 |
| Histidine (HIS) | 670 | 7.8 | 15 |

The essential amino acid in greatest deficit in the collagen peptide in comparison to the amino acid scoring pattern is tryptophan. Since the amount of tryptophan contained in the collagen peptide is 0.1 mg/g protein relative to the amount of tryptophan being 6 mg/g protein in the amino acid scoring, the amino acid score of the collagen peptide is (0.1/6.0)×100≈1.7.

As shown in Table 1, the amino acid scoring pattern shows the amount of methionine in the form of a total amount of methionine and cystine, which is a non-essential amino acid, and shows the amount of phenylalanine in the form of a total amount of phenylalanine and tyrosine, which is a non-essential amino acid.

### (Test Example 2) Method for Determining Blending Ratio of Essential Amino Acids

Table 2 shows the types and the content (M2) of essential amino acids needed to make the amino acid score of a food containing the above-mentioned collagen peptide 100. The “amounts of amino acids insufficient to make the amino acid score 100 [M2]” shown in the table are the content of amino acids in a 100 g food that contains a 40 g (40% by mass) collagen peptide.

TABLE 2

| | | | | | | Amounts of |
|---|---|---|---|---|---|---|
| | | | | | | amino acids |
| | | | | | | insufficient |
| | | Collagen peptide | | | | to make the |
| | | Amount | Amount | Amino acid | Insufficient | amino acid score |
| | | per 100 g | per 1 g | scoring | amount | 100 [M2] |
| | | of collagen | of protein | pattern | [M1] | (g/100 g food) |
| | | peptide | (mg/g | (mg/g | (mg/g | M2 = M1 × |
| Amino acid | | (mg/100 g) | protein) | protein) | protein) | 40 × 0.876/1000* |
| Isoleucine (ILE) | | 1200 | 14.0 | 30 | 16.0 | 0.561 |
| Leucine (LEU) | | 2900 | 34.0 | 59 | 25.0 | 0.876 |
| Lysine (LYS) | | 3600 | 42.0 | 45 | 3.0 | 0.105 |
| Sulfur- | Methionine (MET) | 830 | 9.6 | — | — | — |
| containing | Cystine (CYS) | 17 | 0.2 | — | — | — |
| amino acid | Total | 850 | 9.8 | 22 | 12.2 | 0.427 |
| (AAS) | | | | | | |
| Aromatic | Phenylalanine (PHE) | 2000 | 23.0 | — | — | — |
| amino acid | Tyrosine (TYR) | 280 | 3.3 | — | — | — |
| (AAA) | Total | 2300 | 26.0 | 38 | 12.0 | 0.420 |

| | | | | | |
|---|---|---|---|---|---|
| Threonine (THR) | 2000 | 23.0 | 23 | 0.0 | 0.000 |
| Tryptophan (TRP) | 7.7 | 0.1 | 6 | 5.9 | 0.207 |
| Valine (VAL) | 2700 | 31.0 | 39 | 8.0 | 0.280 |
| Histidine (HIS) | 670 | 7.8 | 15 | 7.2 | 0.252 |

*Content of collagen peptide in 100 g of food: 40 mass %
Protein content in collagen peptide: 87.6 mass %

### Test Example 3

### 3-1. Example 1

A gel-like food was produced by the following method. The materials used here and the blending ratio (% by mass) thereof are as shown in Table 3.

Water, a vegetable oil (salad oil), and a dextrin were poured into a stirrer and mixed. A collagen peptide (“ROUSSELOT PEPTAN P 2000HD,” manufactured by Rousselot BV) was added to the mixed solution, and the mixture was stirred. The collagen peptide used here is a collagen peptide derived from a pig, and has the same amino acid composition as that of the collagen peptide described in Test Examples 1 and 2. Next, dried egg white (gelling agent 1) as a gelling agent, citric acid as an acidulant, acesulfame potassium as a sweetener, and caramel color as a colorant were added and stirred.

Then, various amino acids were added and stirred. The types and amounts of amino acids to be added were determined as shown in Table 3 such that the amino acid score became 100, based on the “amounts of amino acids insufficient to make the amino acid score 100 [M2]” shown in Table 2. Then, chocolate flavor was added as a flavorant and stirred. The resulting solution was transferred to a filling machine, from which a 100 mL cup was filled with 50 g of the solution. The top of the cup was sealed with a film, followed by heat-sterilization. The heating conditions were 90° C. and 30 minutes. After allowing the resultant to cool slightly, the resultant was transferred to a refrigerator and cooled at 5° C. for 1 hour to obtain a gel-like food.

### 3-2. Examples 2 to 15 and Comparative Examples 1 to 2

Gel-like foods were produced in the same manner as in Example 1 except that the blending ratio of water and collagen peptide was changed as shown in Table 3. When the blending ratio of water and collagen peptide was changed, the blending ratio of vegetable oil or dextrin may have been changed for adjustment.

### 3-3. Example 16

A gel-like food was produced in the same manner as in Example 9 except that an emulsified oil and fat (“AR white,” manufactured by NOF Corporation) was used as a liquid oil and fat in combination with vegetable oil (salad oil). When the emulsified oil and fat was added, the blending ratio of dextrin was changed.

### 3-4. Example 17

A gel-like food was produced in the same manner as in Example 9 except that carrageenan (gelling agent 2) and locust bean gum (gelling agent 3) were used as gelling agents instead of dried egg white (gelling agent 1).

TABLE 3

| | Blending ratio (mass %) | | | | | | | | | |
|---|---|---|---|---|---|---|---|---|---|---|
| Ingredient | Ex. 1 | Ex. 2 | Ex. 3 | Ex. 4 | Ex. 5 | Ex. 6 | Ex. 7 | Ex. 8 | Ex. 9 | Ex. 10 |
| Collagen peptide | 30.000% | 40.000% | 50.000% | 30.000% | 40.000% | 50.000% | 60.000% | 30.000% | 40.000% | 50.000% |
| Gelling agent 1 | 1.000% | 1.000% | 1.000% | 1.000% | 1.000% | 1.000% | 1.000% | 1.000% | 1.000% | 1.000% |
| Gelling agent 2 | 0.000% | 0.000% | 0.000% | 0.000% | 0.000% | 0.000% | 0.000% | 0.000% | 0.000% | 0.000% |
| Gelling agent 3 | 0.000% | 0.000% | 0.000% | 0.000% | 0.000% | 0.000% | 0.000% | 0.000% | 0.000% | 0.000% |
| Citric acid (acidulant) | 0.120% | 0.120% | 0.120% | 0.120% | 0.120% | 0.120% | 0.120% | 0.120% | 0.120% | 0.120% |
| Chocolate flavor | 0.300% | 0.300% | 0.300% | 0.300% | 0.300% | 0.300% | 0.300% | 0.300% | 0.300% | 0.300% |
| L-histidine | 0.252% | 0.252% | 0.252% | 0.252% | 0.252% | 0.252% | 0.252% | 0.252% | 0.252% | 0.252% |
| L-isoleucine | 0.561% | 0.561% | 0.561% | 0.561% | 0.561% | 0.561% | 0.561% | 0.561% | 0.561% | 0.561% |
| L-leucine | 0.876% | 0.876% | 0.876% | 0.876% | 0.876% | 0.876% | 0.876% | 0.876% | 0.876% | 0.876% |
| L-lysine hydrochloride | 0.132% | 0.132% | 0.132% | 0.132% | 0.132% | 0.132% | 0.132% | 0.132% | 0.132% | 0.132% |
| L-methionine | 0.214% | 0.214% | 0.214% | 0.214% | 0.214% | 0.214% | 0.214% | 0.214% | 0.214% | 0.214% |
| L-cystine | 0.214% | 0.214% | 0.214% | 0.214% | 0.214% | 0.214% | 0.214% | 0.214% | 0.214% | 0.214% |
| L-phenylalanine | 0.210% | 0.210% | 0.210% | 0.210% | 0.210% | 0.210% | 0.210% | 0.210% | 0.210% | 0.210% |
| L-tyrosine | 0.210% | 0.210% | 0.210% | 0.210% | 0.210% | 0.210% | 0.210% | 0.210% | 0.210% | 0.210% |
| L-threonine | 0.000% | 0.000% | 0.000% | 0.000% | 0.000% | 0.000% | 0.000% | 0.000% | 0.000% | 0.000% |
| L-tryptophan | 0.207% | 0.207% | 0.207% | 0.207% | 0.207% | 0.207% | 0.207% | 0.207% | 0.207% | 0.207% |
| L-valine | 0.280% | 0.280% | 0.280% | 0.280% | 0.280% | 0.280% | 0.280% | 0.280% | 0.280% | 0.280% |
| Sweetener | 0.071% | 0.071% | 0.071% | 0.071% | 0.071% | 0.071% | 0.071% | 0.071% | 0.071% | 0.071% |
| Vegetable oil | 20.000% | 20.000% | 20.000% | 20.000% | 20.000% | 20.000% | 10.000% | 20.000% | 20.000% | 10.000% |
| Emulsified oil and fat | 0.000% | 0.000% | 0.000% | 0.000% | 0.000% | 0.000% | 0.000% | 0.000% | 0.000% | 0.000% |
| Caramel | 0.400% | 0.400% | 0.400% | 0.400% | 0.400% | 0.400% | 0.400% | 0.400% | 0.400% | 0.400% |
| Dextrin | 29.953% | 19.953% | 9.953% | 24.953% | 14.953% | 4.953% | 4.953% | 19.953% | 9.953% | 9.953% |
| Water | 15.000% | 15.000% | 15.000% | 20.000% | 20.000% | 20.000% | 20.000% | 25.000% | 25.000% | 25.000% |
| Total | 100.000% | 100.000% | 100.000% | 100.000% | 100.000% | 100.000% | 100.000% | 100.000% | 100.000% | 100.000% |
| Amino acid score | 100 | 100 | 100 | 100 | 100 | 100 | 100 | 100 | 100 | 100 |

| | Blending ratio (mass %) | | | | | | | | |
|---|---|---|---|---|---|---|---|---|---|
| Ingredient | Ex. 11 | Ex. 12 | Ex. 13 | Ex. 14 | Ex. 15 | Ex. 16 | Ex. 17 | Comp. Ex. | Comp. Ex. 2 |
| Collagen peptide | 60.000% | 30.000% | 40.000% | 50.000% | 50.000% | 40.000% | 40.000% | 30.000% | 40.000% |
| Gelling agent 1 | 1.000% | 1.000% | 1.000% | 1.000% | 1.000% | 1.000% | 0.000% | 1.000% | 1.000% |
| Gelling agent 2 | 0.000% | 0.000% | 0.000% | 0.000% | 0.000% | 0.000% | 0.500% | 0.000% | 0.000% |
| Gelling agent 3 | 0.000% | 0.000% | 0.000% | 0.000% | 0.000% | 0.000% | 0.500% | 0.000% | 0.000% |
| Citric acid (acidulant) | 0.120% | 0.120% | 0.120% | 0.120% | 0.120% | 0.120% | 0.120% | 0.120% | 0.120% |
| Chocolate flavor | 0.300% | 0.300% | 0.300% | 0.300% | 0.300% | 0.300% | 0.300% | 0.300% | 0.300% |
| L-histidine | 0.252% | 0.252% | 0.252% | 0.252% | 0.252% | 0.252% | 0.252% | 0.252% | 0.252% |
| L-isoleucine | 0.561% | 0.561% | 0.561% | 0.561% | 0.561% | 0.561% | 0.561% | 0.561% | 0.561% |
| L-leucine | 0.876% | 0.876% | 0.876% | 0.876% | 0.876% | 0.876% | 0.876% | 0.876% | 0.876% |
| L-lysine hydrochloride | 0.132% | 0.132% | 0.132% | 0.132% | 0.132% | 0.132% | 0.132% | 0.132% | 0.132% |
| L-methionine | 0.214% | 0.214% | 0.214% | 0.214% | 0.214% | 0.214% | 0.214% | 0.214% | 0.214% |
| L-cystine | 0.214% | 0.214% | 0.214% | 0.214% | 0.214% | 0.214% | 0.214% | 0.214% | 0.214% |
| L-phenylalanine | 0.210% | 0.210% | 0.210% | 0.210% | 0.210% | 0.210% | 0.210% | 0.210% | 0.210% |
| L-tyrosine | 0.210% | 0.210% | 0.210% | 0.210% | 0.210% | 0.210% | 0.210% | 0.210% | 0.210% |
| L-threonine | 0.000% | 0.000% | 0.000% | 0.000% | 0.000% | 0.000% | 0.000% | 0.000% | 0.000% |
| L-tryptophan | 0.207% | 0.207% | 0.207% | 0.207% | 0.207% | 0.207% | 0.207% | 0.207% | 0.207% |
| L-valine | 0.280% | 0.280% | 0.280% | 0.280% | 0.280% | 0.280% | 0.280% | 0.280% | 0.280% |
| Sweetener | 0.071% | 0.071% | 0.071% | 0.071% | 0.071% | 0.071% | 0.071% | 0.071% | 0.071% |
| Vegetable oil | 5.000% | 20.000% | 20.000% | 10.000% | 5.000% | 20.000% | 20.000% | 20.000% | 10.000% |
| Emulsified oil and fat | 0.000% | 0.000% | 0.000% | 0.000% | 0.000% | 5.000% | 0.000% | 0.000% | 0.000% |
| Caramel | 0.400% | 0.400% | 0.400% | 0.400% | 0.400% | 0.400% | 0.400% | 0.400% | 0.400% |
| Dextrin | 4.953% | 14.953% | 4.953% | 4.953% | 4.953% | 4.953% | 9.953% | 4.953% | 4.953% |
| Water | 25.000% | 30.000% | 30.000% | 30.000% | 35.000% | 25.000% | 25.000% | 40.000% | 40.000% |
| Total | 100.000% | 100.000% | 100.000% | 100.000% | 100.000% | 100.000% | 100.000% | 100.000% | 100.000% |
| Amino acid score | 100 | 100 | 100 | 100 | 100 | 100 | 100 | 100 | 100 |

### 3-5. Evaluation

### 3-5-1. Evaluation of Ability to Suppress Odor and Taste Originating in Amino Acids (1)

Trained panelists assessed the odor and taste, in which bitterness specific to essential amino acids was the main taste characteristic, of each of the gel-like foods of Examples 1 to 15 and Comparative Examples 1 and 2. The evaluation criteria were as follows. The results are shown in Table 4.

### <Evaluation Criteria for Flavor>

A: No odor or taste specific to essential amino acids is felt.

B: The odor and taste specific to essential amino acids are slightly present, but hardly noticeable.

C: The odor and taste specific to essential amino acids are felt to a noticeable extent.

TABLE 4

| | | Water content (mass %) | | | | | |
|---|---|---|---|---|---|---|---|
| | | 15 | 20 | 25 | 30 | 35 | 40 |
| Content of | 30 | Ex. 1 | Ex. 4 | Ex. 8 | Ex. 12 | — | Com. Ex. 1 |
| Collagen | | A | B | B | B | — | C |
| peptide | 40 | Ex. 2 | Ex. 5 | Ex. 9 | Ex. 13 | — | Com. Ex. 2 |
| (mass %) | | A | A | B | B | — | C |
| | 50 | Ex. 3 | Ex. 6 | Ex. 10 | Ex. 14 | Ex. 15 | — |
| | | A | A | A | A | B | — |
| | 60 | — | Ex. 7 | Ex. 11 | — | — | — |
| | | — | A | A | — | — | — |

It is found from Table 4 that the odor and taste originating in essential amino acids are masked by reducing the water content. It is also found that a further masking effect can be obtained by adjusting the content of the collagen peptide.

### 3-5-2. Evaluation of Ability to Suppress Odor and Taste Originating in Amino Acids (2)

The odor and taste originating in essential amino acids were assessed for the gel-like food of Example 16 by the same evaluation method as described above. The results are shown in Table 5. Table 5 shows the results of the evaluation of Example 16 in addition to the results shown in Table 4.

TABLE 5

| | | Water content (mass %) | | | | | | |
|---|---|---|---|---|---|---|---|---|
| | | 15 | 20 | 25 | | 30 | 35 | 40 |
| Content of | 30 | Ex. 1 | Ex. 4 | Ex. 8 | — | Ex. 12 | — | Com. Ex. 1 |
| Collagen | | A | B | B | — | B | — | C |
| peptide | 40 | Ex. 2 | Ex. 5 | Ex. 9 | Ex. 16 | Ex. 13 | — | Com. Ex. 2 |
| (mass %) | | A | A | B | A | B | — | C |
| | 50 | Ex. 3 | Ex. 6 | Ex. 10 | — | Ex. 14 | Ex. 15 | — |
| | | A | A | A | — | A | B | — |
| | 60 | — | Ex. 7 | Ex. 11 | — | — | — | — |
| | | — | A | A | — | — | — | — |

As described above, Example 16 is an example in which an emulsified oil and fat (“AR white,” manufactured by NOF Corporation) was used as a liquid oil and fat in combination with vegetable oil (salad oil) with respect to Example 9. From the comparison between Example 9 and Example 16 shown in Table 5, it is found that the effect of masking the odor and taste originating in amino acids is improved by using an emulsified oil and fat having a milky feeling in combination with vegetable oil.

### 3-5-3. Evaluation of Hardness and Adhesiveness

The hardness and adhesiveness of the gel-like foods of Examples 9 and 17 were measured. “Tensipresser My Boy II System” (manufactured by Taketomo Electric Co., Ltd.) was used as a measurement device, and the above-described method was used as a measurement method. The results are shown in Table 6.

TABLE 6

| | Hardness | Adhesiveness |
|---|---|---|
| | [N/m²] | [J/m³] |
| Example 9 | 4.2 × 10³ | 3.0 × 10³ |
| Example 17 | 4.9 × 10³ | 5.2 × 10² |

As described above, Example 17 is an example in which carrageenan (gelling agent 2) and locust bean gum (gelling agent 3) were used as gelling agents instead of dried egg white (gelling agent 1) with respect to Example 9. It is found from Table 6 that the adhesiveness can be reduced by the selection of the gelling agent.

The present invention is not limited to the foregoing embodiments. For practical implementation, various modifications may be made without departing from the gist of the invention. The embodiments may be discretionarily combined for implementation, and such combinations will produce combined effects. Moreover, the embodiments involve various aspects, and appropriate combinations of the disclosed features will permit various inventions to be derived. For example, if omission of several features from the entire configuration or structure disclosed for the embodiments can still realize the intended object and provide the effects, the configuration or structure after such omission may be derived as an invention.

1. A protein-containing food comprising a collagen peptide, one or more essential amino acids selected from histidine, isoleucine, leucine, lysine, methionine, phenylalanine, threonine, tryptophan, and valine, and water, wherein a content of the water is 35% by mass or less, and a content of the collagen peptide is 30% by mass or more.

2. The protein-containing food according to claim 1, wherein a content of a protein derived from the collagen peptide is 30% by mass or more.

3. The protein-containing food according to claim 1, wherein the content of the collagen peptide is in a range of 30% by mass or more and less than 70% by mass.

4. The protein-containing food according to claim 1, wherein the content of the water is in a range of 10% by mass or more and 33% by mass or less.

5. The protein-containing food according to claim 1, wherein the protein-containing food has an amino acid score of 100.

6. The protein-containing food according to claim 1, further comprising one or more non-essential amino acids, wherein at least tyrosine or cystine is contained as the one or more non-essential amino acids.

7. The protein-containing food according to claim 1, wherein the protein-containing food contains a gelling agent and is a food for a person with dysphagia having a hardness of 5.0×10⁴ N/m² or less.

8. The protein-containing food according to claim 7, wherein the protein-containing food has an adhesiveness of 1.5×10³ J/m³ or less.

9. The protein-containing food according to claim 7, wherein the protein-containing food contains, as the gelling agent, one or more selected from carrageenan, alginic acid or a salt thereof, pectin, agar, konjac, curdlan, xanthan gum, locust bean gum, tamarind seed gum, and gelatin.

10. The protein-containing food according to claim 7, wherein the protein-containing food is any of gel-like foods including bavarois, mousse, jelly, pudding, almond jelly, and sweet bean jelly.

11. The protein-containing food according to claim 1, further comprising a liquid oil and fat.

12. The protein-containing food according to claim 11, wherein the protein-containing food contains, as the liquid oil and fat, one or more selected from a vegetable oil and an emulsified oil and fat.

13. A method for producing a protein-containing food, the method comprising:
mixing water and a collagen peptide to obtain a first solution in which the collagen peptide is dissolved;
adding one or more essential amino acids selected from histidine, isoleucine, leucine, lysine, methionine, phenylalanine, threonine, tryptophan, and valine to the first solution to obtain a second solution in which the one or more essential amino acids are dispersed; and
sterilizing the second solution by heating.
